(19) United States
(12) Patent Application Publication
(10) Pub. No.: US 2013/0037303 A1
(43) Pub. Date: Feb. 14, 2013

(54) FLEXIBLE FLAT CABLE

(71) Applicant: CHIEN-CHUN WANG, Taoyuan City (TW)

(72) Inventor: CHIEN-CHUN WANG, Taoyuan City (TW)

(73) Assignee: P-Two Industries Inc., Taoyuan City (TW)

(21) Appl. No.: 13/352,184

(22) Filed: Jan. 17, 2012

(30) Foreign Application Priority Data
Aug. 11, 2011 (TW) 100214977
Sep. 14, 2011 (TW) 100217252

(51) Int. Cl. H01B 7/08

(52) U.S. Cl. 174/117 FF

(57) ABSTRACT

A flexible flat cable, including a plurality of preprocess conductors and a insulating layer, wherein the insulating layer includes upper and lower insulating layers, each of the preprocess conductors has upper and lower faces and an original width, and the upper and lower faces are being flat and attached tightly and closely to the upper and lower insulating layers, respectively. Ends of the preprocess conductors expose out of the insulating layer and are being processed to form a plurality of contact faces, and each of the contact faces has a processed width which is larger than the original width.

### BACKGROUND OF THE INVENTION

1. Field of the Invention

The present invention relates to a flexible flat cable, and particularly to a flexible flat cable having a structure that is easily to be operated for cutting and dividing processes and manufactured at a low cost.

2. Related Art

A flexible flat cable (FFC), a type of data cables, consists of very thin and flat tin plated copper wires being hot pressed with polyethylene terephthalate (PET) insulating material through a high tech automated production line. FFC, also a type of signal transmission elements, has advantages of flexibility and ability to transmit high-frequency signals and therefore has been widely applied in many electronic products.

Referring to FIG. 1 illustrating a structure of a conventional FFC, the conventional FFC has an upper insulating layer 11, a plurality of wires 12, and a lower insulating layer 13, which are being stacked in sequence by means of hot press technique, wherein the plurality of wires 12 are spaced apart from each other, and ends of the wires 12 expose out of the FFC to form contact points. Because the wires 12 of the conventional FFC has been through the rolling process prior to being hot pressed, the wires 12 become flat in whole and thus the exposing part and a middle part of the wires 12 have the same width. However, when the contact points of the wires 12 are to be arranged closely and the middle part of the FFC is to be cut into lines, too small pitches of the wires will result in a lower yield rate of cutting processes for the conventional FFC.

Please refer to FIGS. 2A and 2B both illustrating another structure of the conventional FFC. In different system environments, the wires 12 can be round copper wires which are not being rolled. Although the pitches of the round copper wires 12 are large enough for cutting and dividing processes, the outer surfaces of round copper wires are difficult for the process of hot press with the upper insulating layer 11 and the lower insulating layer 13, and thus the wires 12 are not tightly attached to the upper insulating layer 11 and the lower insulating layer 13. Besides, ends of the round copper wires are inappropriate for press-contact.

Referring to FIGS. 3A and 3B showing an improved structure of a flexible flat cable, the wires 12 covered by the upper and lower insulating layers 11, 13 include both flat copper wires and round copper wires. The combination of the flat and round copper wires is intended to improve overall impedance of the FFC, not for manufacture procedures or cutting and dividing processes. Consequently, the FFC shown in FIGS. 3A and 3B still has drawbacks of the two types of conventional FFCs as mentioned above.

Additionally, Taiwan Patent No. M287495 discloses another FFC of which the height and width of the wires are varied so as to properly adjust the impedance. Although the shape of the wires can be varied in this patent as shown in FIGS. 4A and 4B, pitches of the wires 12 in the referenced patent remain the same without any change. That is, when the exposing part of wires are arranged closely, the middle part of the wires remains the same pitches as that of the exposing part, which causes, as mentioned above, the cutting and dividing processes difficult.

Moreover, Taiwan Patent No. M350793 discloses another FFC having stacked wires. However, this type of FFC still fail to cope with insufficient pitches of the wires, and the structure of such FFC is too complex to lower the manufacture cost.

### SUMMARY OF THE INVENTION

Accordingly, an object of the present invention is to provide a flexible flat cable which has an improved structure capable of being easily operated for cutting and dividing process.

Another object of the present invention is to provide a flexible flat cable which overcomes a problem that conventional round wires are not closely and tightly attached to insulating layers after being hot pressed.

To achieve the above mentioned objects, a flexible flat cable of the present invention comprises a plurality of preprocess conductors and an insulating layer, wherein the insulating layer includes upper and lower insulating layers, each of the preprocess conductors has upper and lower faces and an original width, and the upper and lower faces are being flat and attached tightly and closely to the upper and lower insulating layers, respectively. Ends of the preprocess conductors expose out of the insulating layer and are being processed to form a plurality of contact faces, and each of the contact faces has a processed width which is larger than the original width.

The flexible flat cable of the present invention is to utilize the original width of the preprocess conductors which is shorter than the processed width to provide enlarged pitches of the preprocess conductors so as to facilitate cutting and dividing processes. Furthermore, the flat upper and lower faces of the preprocess conductors are easily to be hot pressed with the upper and lower insulating layers closely and tightly whereby to improve a yield rate and to effectively lower manufacturing cost.

### BRIEF DESCRIPTION OF THE DRAWINGS

FIG. 1 is a perspective view of a conventional flexible flat cable;

FIG. 2A is a perspective view of another conventional flexible flat cable;

FIG. 2B is a schematic cross-sectional view of FIG. 2A;

FIG. 3A is a perspective view of another conventional flexible flat cable;

FIG. 3B is a schematic cross-sectional view of FIG. 3A;

FIG. 4A is a perspective view of another conventional flexible flat cable;

FIG. 4B is a schematic cross-sectional view of FIG. 4A;

FIG. 5 is a perspective view of a flexible flat cable of the present invention;

FIG. 6 is a partial exploded and schematic view of the flexible flat cable of FIG. 5;

FIG. 7 is a partial enlarged view of the flexible flat cable of FIG. 5;

FIG. 8A is a partial cross-sectional view taken along line A-A of FIG. 5;

FIG. 8B is a schematic view showing another embodiment of the present invention;

FIG. 9 is a schematic view showing another embodiment of the present invention;

FIG. 10 is a schematic perspective view showing a plurality of strip portions on a middle part of the flexible flat cable of the present invention;

FIG. 11 is a top plan view of the strip portions of FIG. 10 being folded;

FIG. 12 is schematic perspective view showing the flexible flat cable of the present invention being folded without a wrapping element; and

FIG. 13 is a schematic perspective view showing the flexible flat cable of FIG. 12 being folded and wrapped with the wrapping element.

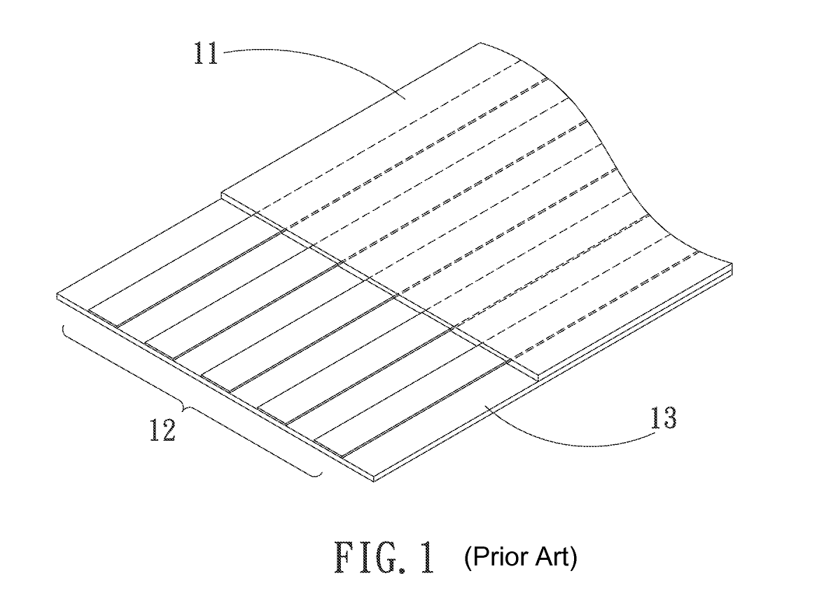

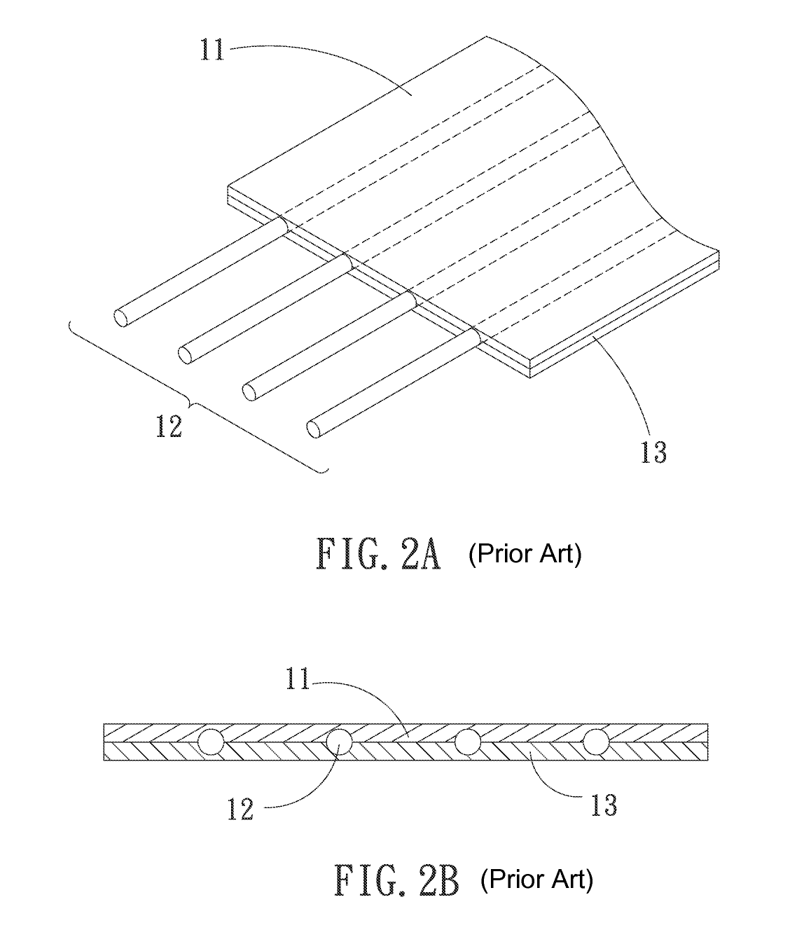

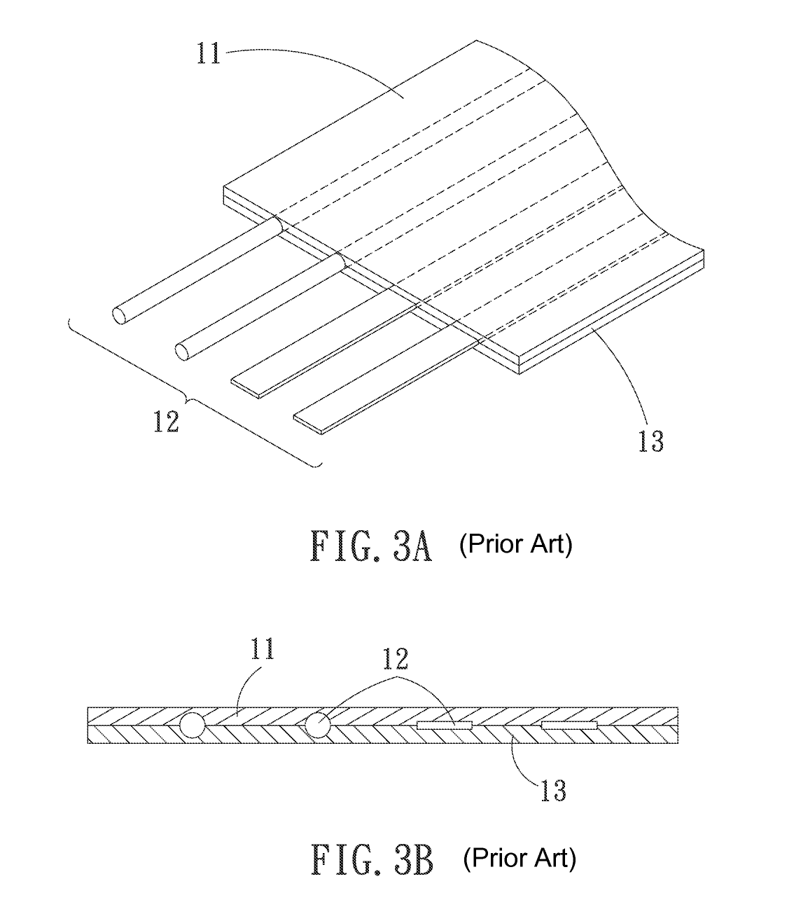

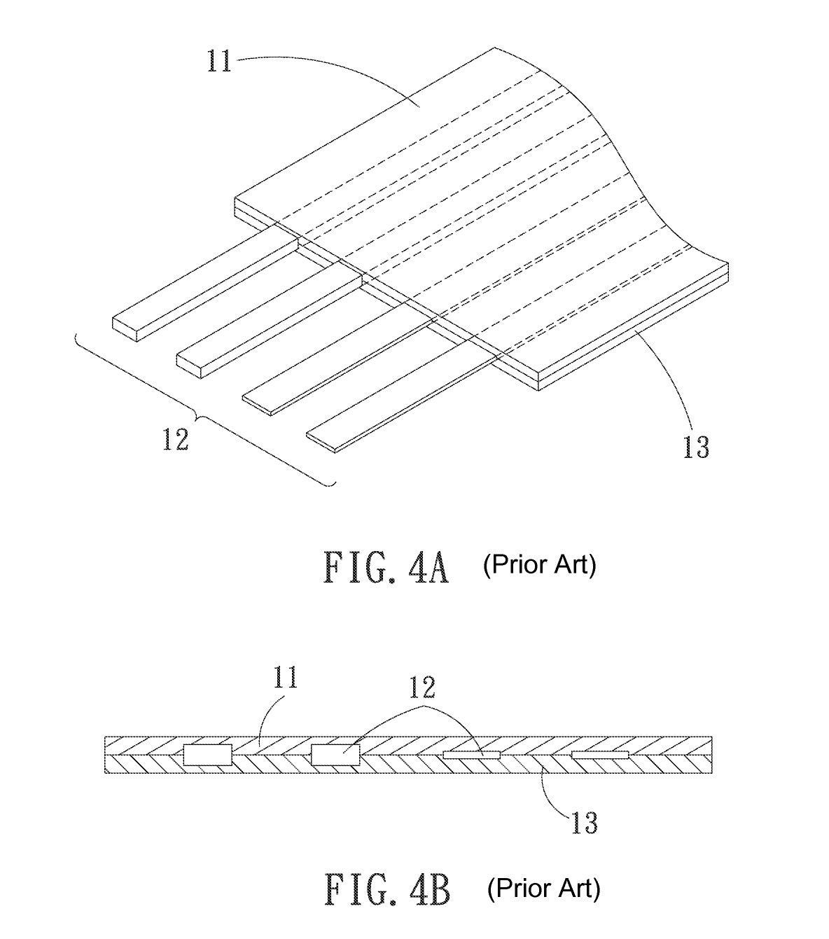

### DESCRIPTION OF THE PREFERRED EMBODIMENTS

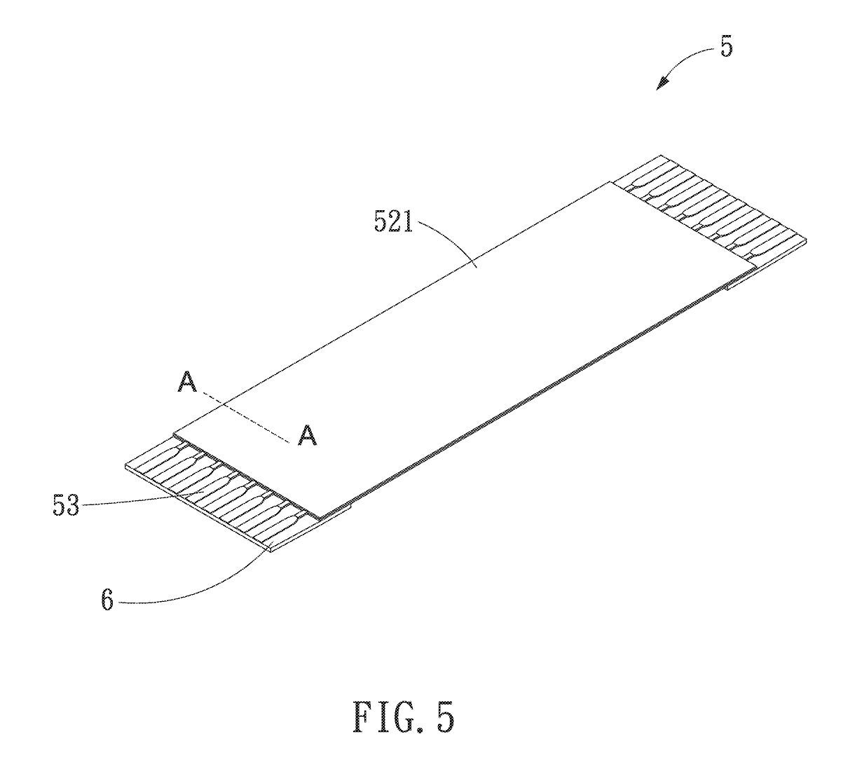

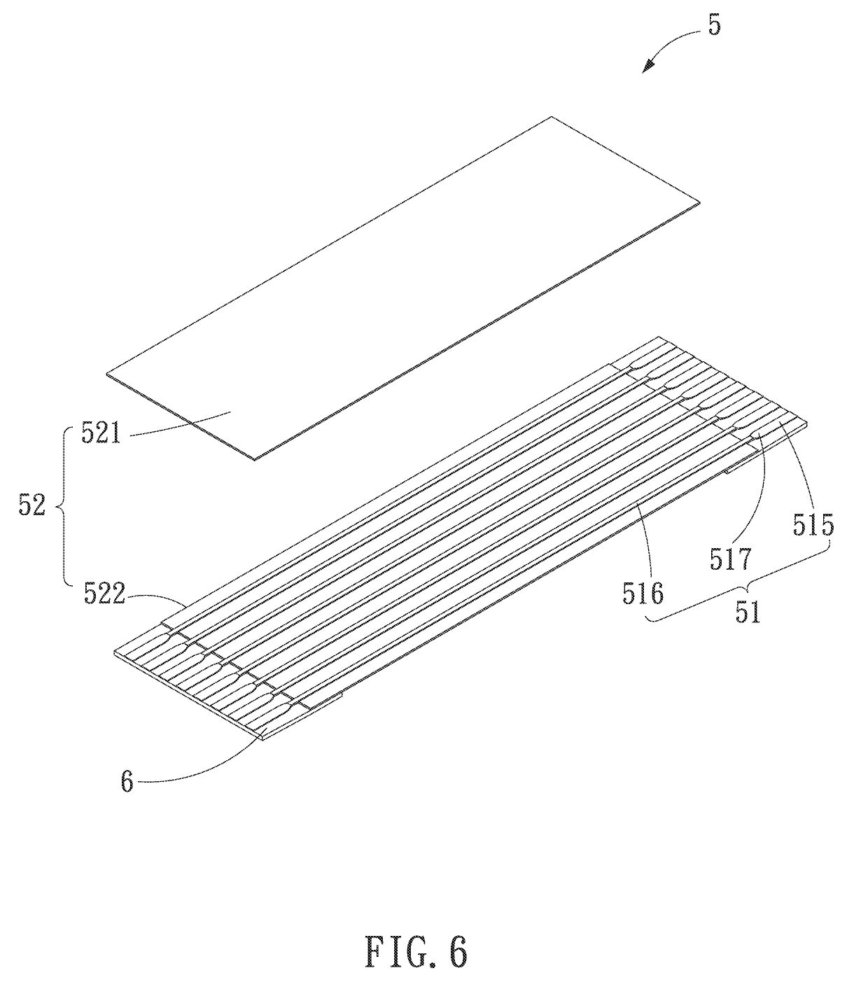

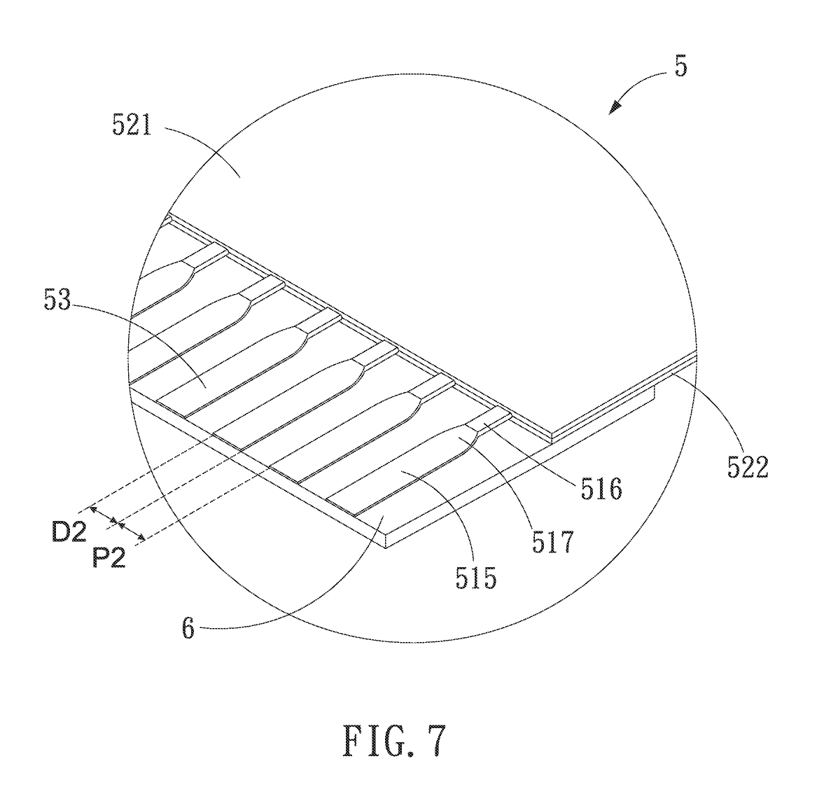

Please refer to FIGS. 5 to 8A showing a flexible flat cable of one of the preferred embodiments of the present invention.

The flexible flat cable 5 comprises a plurality of preprocess conductors 51 being disposed in parallel, and an insulating layer 52 covering the plurality of preprocess conductors 51. The insulating layer 52 includes an upper insulating layer 521 and a lower insulating layer 522. Each of the preprocess conductors 51 has an upper face 511, a lower face 512, a left side face 513, and a right side face 514, the upper and lower faces 511, 512 being flat and parallel to each other and attached tightly and closely to the upper and lower insulating layers 521, 522, respectively. The left and right side faces 513, 514 are arc faces and symmetrical to each other and connect the left and right edges of the upper and lower faces 511, 512, respectively. A width of the upper face 511 is substantially same as a width of the lower face 512, and an arc length of the left side face 513 is substantially same as an arc length of the right side face 514. The upper and lower faces 511, 512 and the left and right side faces 513, 514 cooperatively form an outer surface of the preprocess conductor 51.

Each of the preprocess conductors 51 has an original width D1, and ends of the preprocess conductors 51 expose out of the insulating layer 52 and are being processed to form a plurality of contact faces 53, wherein each contact face 53 has a processed width D2 that is larger than the original width D1 so as to facilitate connection with a mating connector (not shown). In this preferred embodiment, a reinforcement plate 6 is disposed at one end of the flexible flat cable 5, wherein the plurality of contact faces 53 are located on and supported by the reinforcement plate 6 so as to increase the strength of contact faces 53 for connecting with the mating connector.

Each of the ends of the preprocess conductors 51 exposing out of the insulating layer 52 has a connecting portion 515 having the contact face 53, a base portion 516 having the original width D1, and a buffer portion 517 disposed between and used for connecting the base portion 516 and the connecting portion 515. The buffer portion 517 and the connecting portion 515 are being processed where the buffer portion 517 therefore forms inclined faces so as to connect the base portion 516 of a greater height and a smaller width with the connecting portion 515 of a shorter height and a larger width. The underneath of the connecting portion 515 and the buffer portion 517 is not covered by the lower insulating layer 522. In order to strengthen the connection with the mating connector, the connecting portion 515 and the buffer portion 517 are disposed on and supported by the reinforcement plate 6. Alternatively, the lower insulating layer 522 can extend to cover the underneath of the connecting portion 515 and the buffer portion 517 where the lower insulating layer 522 is supported by the reinforcement plate 6, as shown in FIG. 9.

In this preferred embodiment, because a first pitch P1 between the adjacent base portions 516 is larger than a second pitch P2 between the adjacent connecting portions 515, the first pitch P1 is advantageous to subsequent cutting and dividing processes and thus can prevent a yield rate from being reduced by inefficient cutting.

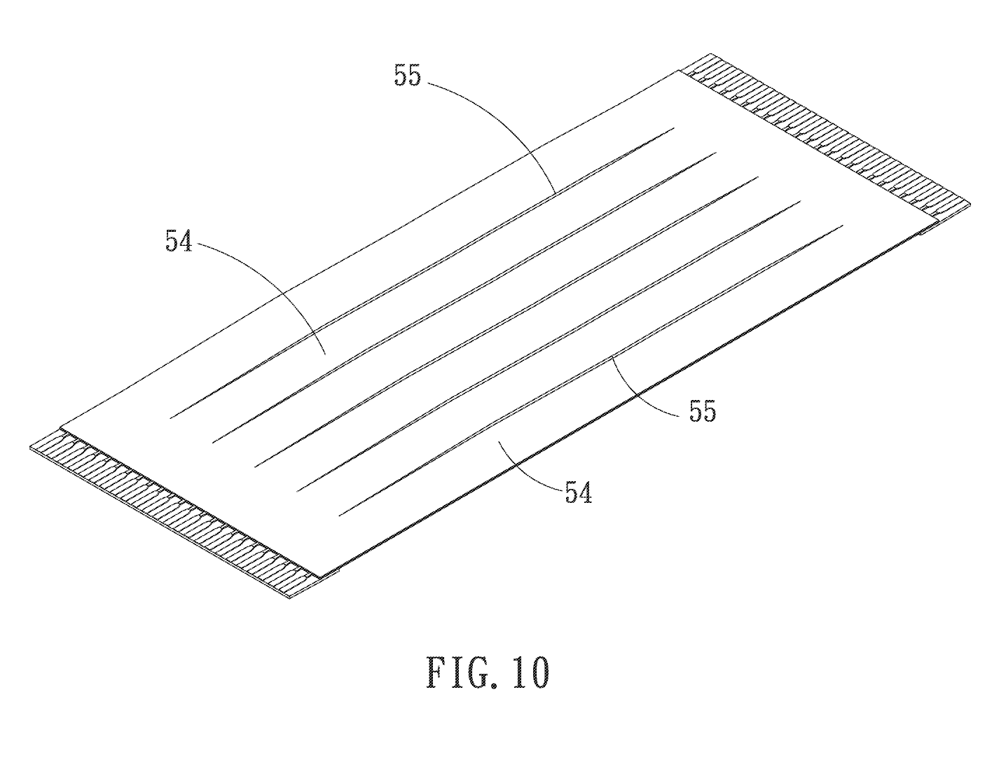

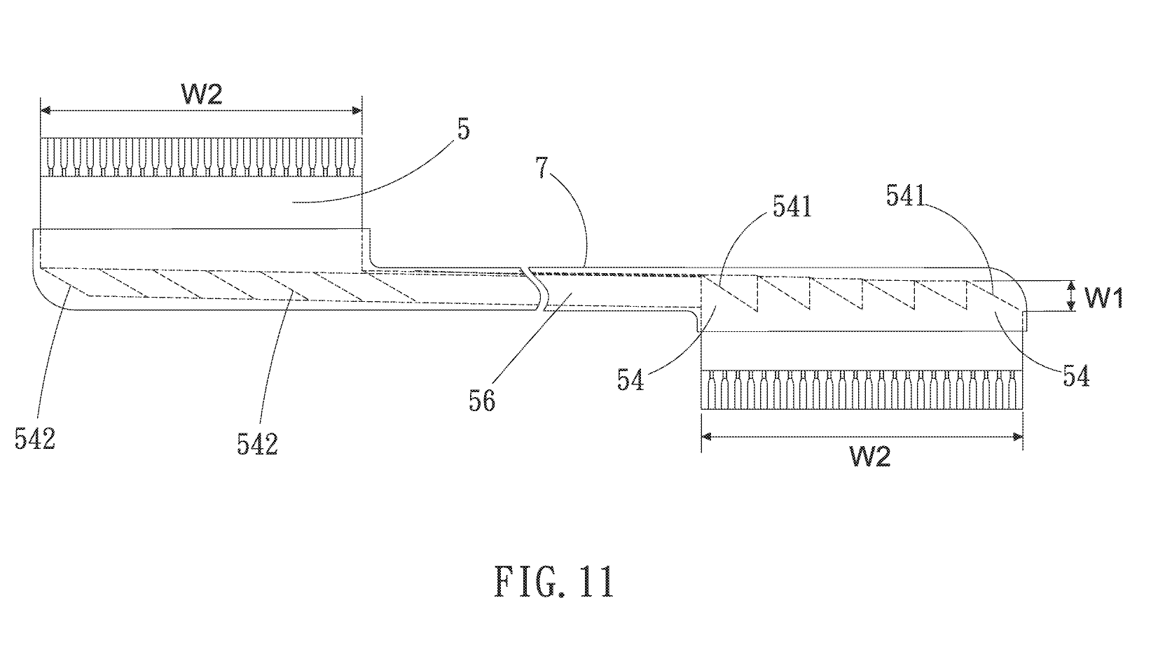

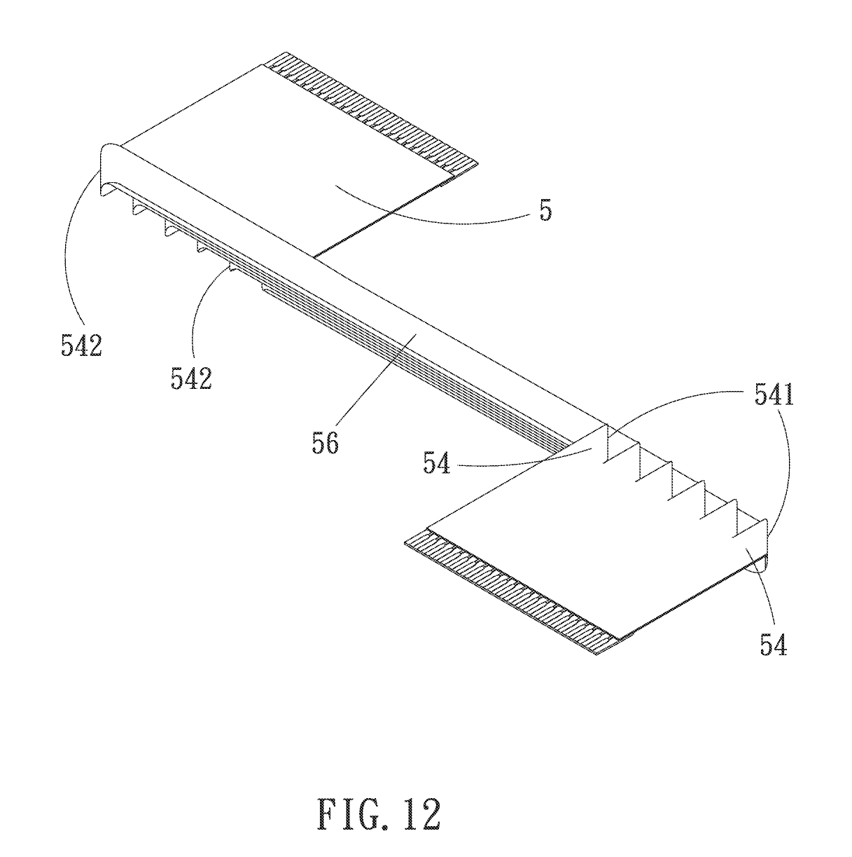

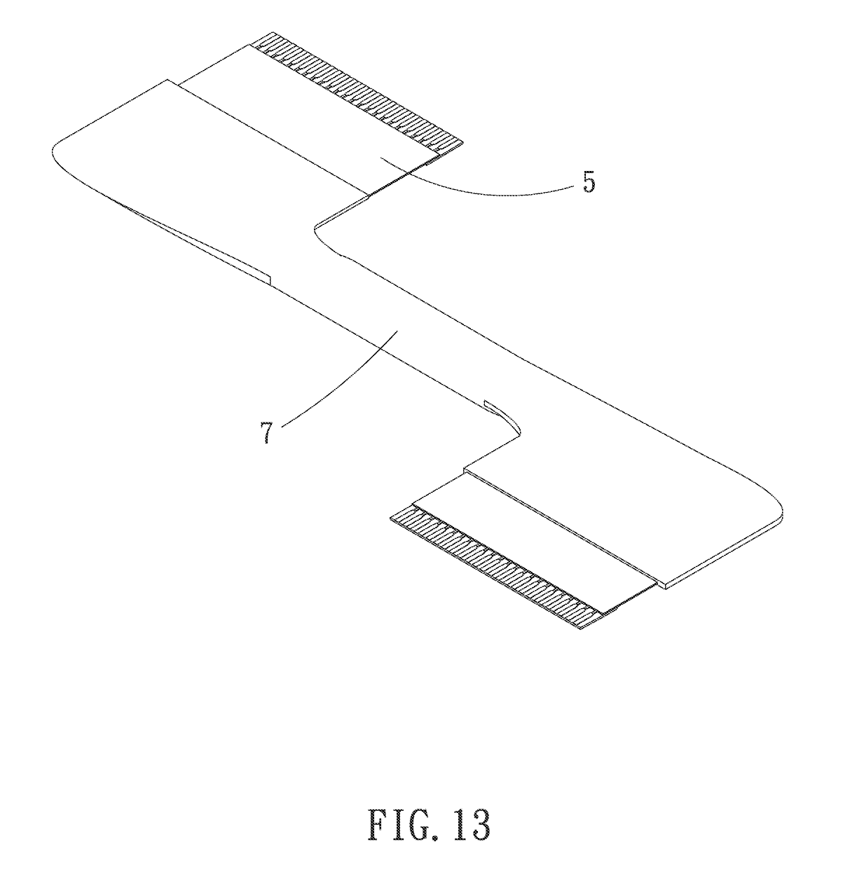

Referring to FIGS. 10 and 11 respectively showing a schematic perspective view of a plurality of strip portions 54 of the flexible flat cable 5 and a top plan view of the strip portion 54 being folded. Furthermore, FIGS. 12 and 13 show before and after use of a wrapping element 7 on the strip portion 54.

The flexible flat cable 5 comprises a plurality of cutting lines 55 extended in an axial direction of the preprocess conductors 51 for cutting the flexible flat cable 5 so as to form the plurality of strip portions 54. Specifically, each of the cutting lines 55 is formed between any two preprocess conductors 51. In this embodiment, each strip portion 54 includes four preprocess conductors 51 or the number of the preprocess conductors 51 can be varied upon practical use. Basically, the more the preprocess conductors 51 are included in one strip portion 54, the larger a width of a folding portion 56 will be.

Each of the strip portions 54 has a first folding line 541 and is folded in a first direction according to the first folding line 541; moreover, the strip portions 54 further has a second folding line 542 and is folded in a second direction according to the second folding line 542. The folding portion 56 is formed between the first and second folding lines 541, 542. In this embodiment, a length direction of the folding portion 56 of each strip portion 54 is substantially perpendicular to the axial direction of the preprocess conductors 51, but not limited thereto. Alternatively, the length direction of the folding portion 56 can be oblique to the axial direction of the preprocess conductors 51 in a determined angle.

The plurality of strip portions 54 are folded to form the plurality of folding portions 56, which overlap and are parallel with each other whereby an overall width W1 of the folding portions 56 is smaller than an original width W2 of the flexible flat cable 5 so as to achieve a purpose of reducing an original width of the flexible flat cable 5 in the short-axis direction.

In this embodiment, for the purpose of fixing, protecting or adjusting the electrical impedance, as shown in FIG. 11 or 13, the flexible flat cable 5 further comprises the wrapping element 7 wrapping the folding portions 56. The wrapping element 7 is made of insulating material, such as an acetate cloth, but not limited thereto. Alternatively, the wrapping element 7 can be made of metal material, such as a conductive cloth, to improve electromagnetic interference. As mentioned above, the flexible flat cable of the present invention is able to be adapted for different interfaces, such as LVDS, SATA, ODD, RJ, PCI, and USB.

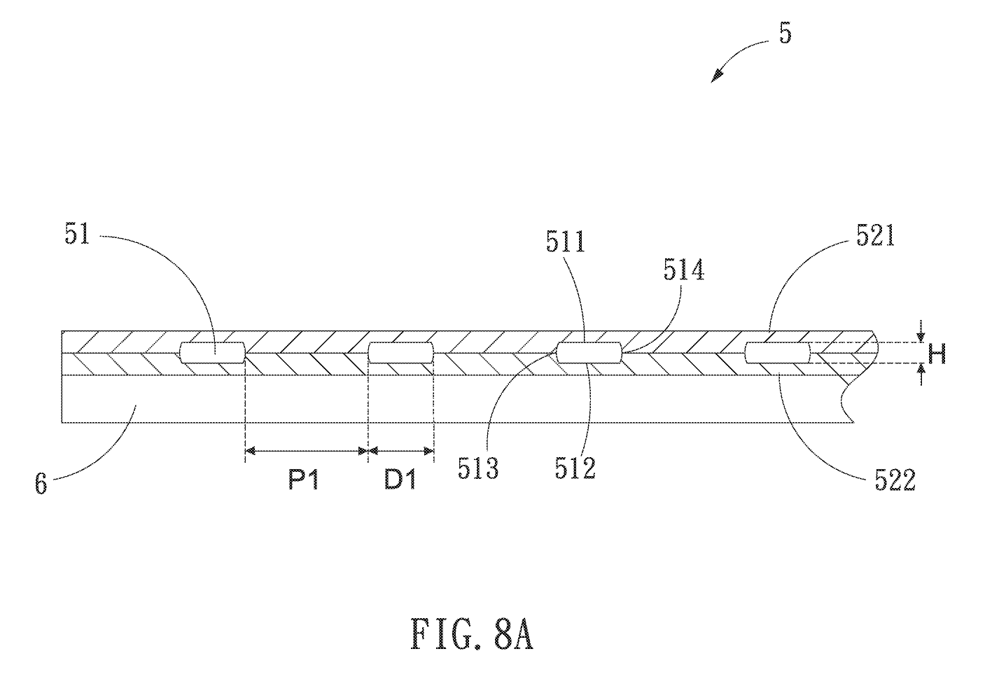

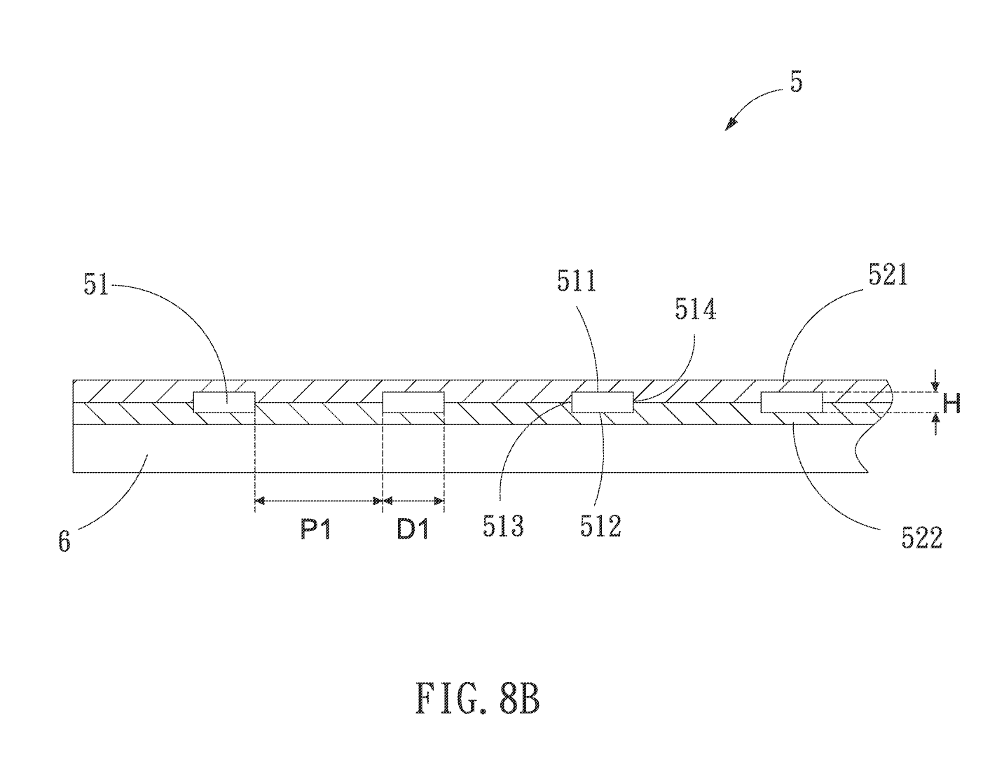

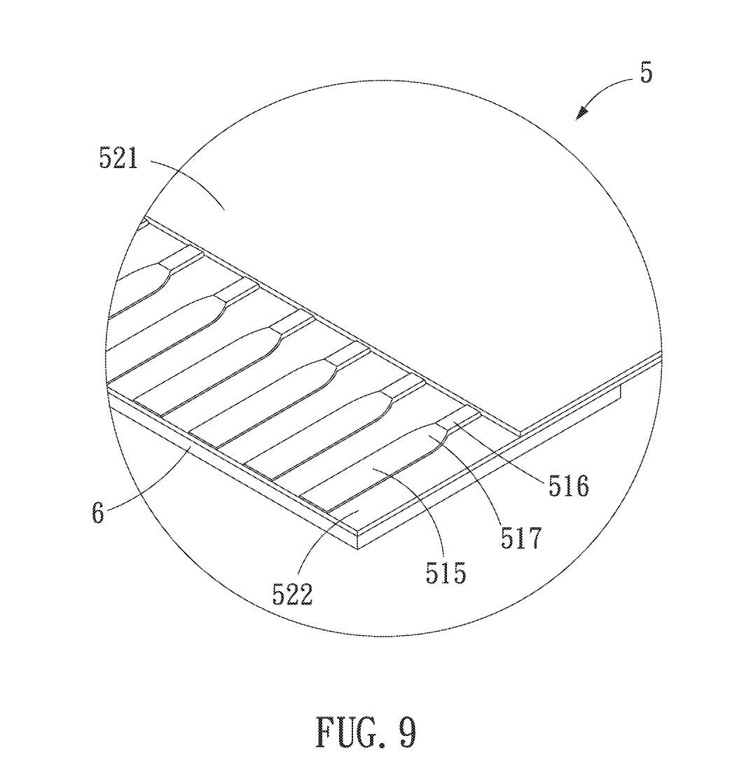

The preprocess conductors 51 are made of metal wires and processed in advance. Therefore, the left and right side faces 513, 514 of the preprocess conductors 51 can also be flat faces probably, as shown in FIG. 8B. A width of the left side face 513 is substantially same as that of the right side face 514, but not limited thereto, other types or shapes of the left and right side faces 513, 514 are also probably formed in the preprocess procedure.

Because the upper and lower faces 511, 512 of the preprocess conductors 51 are flat, it is advantageous to hot press the upper and lower insulating layers 521, 522 with the preprocess conductors 51 in upper and lower directions, respectively, during a bonding cable process. In order to improve a yield rate of the bonding process, a height H between the upper and lower faces 511, 512 and the original width D1 of the preprocess conductor 51 are in a ratio between 1:2 and 1:4, and a preferable ratio of the height H and the original width D1 is 1:3, whereby not only improving the yield rate of the bonding cable process but also facilitating subsequent processes of cutting and dividing.

Accordingly, the flexible flat cable of the present invention is to utilize the shape of the preprocess conductors and the enlarged pitches of the preprocess conductors to facilitate the cutting and dividing processes, inasmuch as the enlarged pitches provide more space for a cutter to being successfully cut thereon to form the strip portions, whereby to prevent a yield rate from being reduced by inefficient cutting and to facilitate the process of hot press for the upper and lower faces of the preprocess conductors and the upper and lower insulating layers, and therefore the manufacturing cost is down. Furthermore, the structure of the folding portions formed by folding the strip portions is capable of achieving the purpose of reducing the original width of the flexible flat cable in the short-axis direction, whereby to overcome a problem that conventional flexible flat cables are unable to be installed in a small or narrow space.

It is understood that the invention may be embodied in other forms within the scope of the claims. Thus the present examples and embodiments are to be considered in all respects as illustrative, and not restrictive, of the invention defined by the claims.

What is claimed is:

1. A flexible flat cable, comprising:
a plurality of preprocess conductors being disposed in parallel, and an insulating layer covering the plurality of preprocess conductors;
wherein the insulating layer includes an upper insulating layer and a lower insulating layer, each of the preprocess conductors having an upper face, a lower face and an original width, the upper and lower faces being flat and attached tightly and closely to the upper and lower insulating layers, respectively, ends of the preprocess conductors exposing out of the insulating layer and being processed to form a plurality of contact faces, and each of the contact faces having a processed width being larger than the original width.

2. The flexible flat cable of claim 1, wherein each of the preprocess conductors further has a left side face and a right side face both connecting left and right edges of the upper and lower faces, respectively, and the upper and lower faces and the left and right side faces cooperatively form an outer surface of the preprocess conductor.

3. The flexible flat cable of claim 1, wherein the upper and lower faces of the preprocess conductor are parallel to each other, a width of the upper face being substantially same as a width of the lower face.

4. The flexible flat cable of claim 2, wherein the left and right side faces are being flat and symmetrical to each other, a width of the left side face being substantially same as a width of the right side face.

5. The flexible flat cable of claim 2, wherein the left and right side faces are arc faces and symmetrical to each other, an arc length of the left side face being substantially same as an arc length of the right side face.

6. The flexible flat cable of claim 1, further comprising a reinforcement plate disposed at one end of the flexible flat cable, wherein the plurality of contact faces are located on and supported by the reinforcement plate.

7. The flexible flat cable of claim 6, wherein each of the preprocess conductors comprises a connecting portion having the contact face, a base portion having the original width, and a buffer portion disposed between the base portion and the connecting portion, the buffer portion exposes out of the insulating layer and is disposed on the reinforcement plate, and a first pitch between the adjacent base portions is larger than a second pitch between the adjacent connecting portions.

8. The flexible flat cable of claim 1, further comprising a plurality of cutting lines being extended in an axial direction of the preprocess conductors for cutting the flexible flat cable so as to form a plurality of strip portions, each of the cutting lines formed between any two of the preprocess conductors, the strip portions being folded to form multiple folding portions which overlap and are parallel with each other, and an overall width of the multiple folding portions being smaller than a width of the flexible flat cable.

9. The flexible flat cable of claim 8, further comprising a wrapping element made of a metal material for wrapping the folding portions.

10. The flexible flat cable of claim 1, wherein a height between the upper and lower faces and the original width of the preprocess conductor are in a ratio between 1:2 and 1:4.
